(19) United States
(12) Patent Application Publication
(10) Pub. No.: US 2004/0066523 A1
(43) Pub. Date: Apr. 8, 2004

(54) Manual duplex imaging method for an imaging apparatus

(76) Inventor: Samuel William Gardiner, Lexington, KY (US)

Correspondence Address: LEXMARK INTERNATIONAL, INC., INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/263,973

(22) Filed: Oct. 3, 2002

(51) Int. Cl. G06K 1/00; G06F 15/00; H04N 1/04

(52) U.S. Cl. 358/1.5; 358/498

(57) ABSTRACT

A method for performing manual duplex imaging includes the steps of communicating a first portion of a data file from a computer to an imaging apparatus to effect imaging on a first side of the print media; reloading the print media into a media supply tray on the imaging apparatus in preparation for imaging on a second side of the print media; sending a signal from the imaging apparatus to the computer indicating that the print media has been reloaded; and communicating a second portion of the data file from the computer to the imaging apparatus in response to the signal to effect imaging of the second side of the print media.

### BACKGROUND OF THE INVENTION

1. Field of the Invention

The present invention relates to an imaging apparatus, and, more particularly, to a manual duplex imaging method for an imaging apparatus.

2. Description of the Related Art

Some imaging apparatus, such as high end electrophotographic and ink jet printers, accommodate duplex printing by including a recirculating duplex paper path to automatically return the print media to the print engine to effect backside printing following front side printing of the print media. However, providing such a recirculating duplex paper path and associated controls add significant complexity and costs to an imaging apparatus. Thus, for example, lower cost imaging apparatus typically do not include a recirculating duplex paper path. Imaging apparatus that do not include a recirculating duplex paper path are often referred to as a simplex imaging apparatus, e.g., a simplex printer.

In order to perform duplex printing on such a simplex printer, it is known to perform manual duplex printing by using a printer driver that formats a print job for duplex printing. Typically, the printer driver generates a text box on a computer monitor to prompt the user during the duplex print job. After first side printing, and in preparation for second side printing, the user then must travel from the computer to the simplex printer, flip the print media and reinsert the print media into a media supply tray of the simplex printer, return to the computer and, using the computer, instruct the printer driver to continue with second side printing. Then, the user must return to the simplex printer to retrieve the completed duplex print job.

While such a method is acceptable when the computer and the imaging apparatus are in very close proximity, such a method is inconvenient when the computer and the imaging apparatus are located remote from one another, such as for example, when the computer and the imaging apparatus are located in different rooms.

What is needed in the art is an improved manual duplex imaging method which avoids the need for a user to make multiple trips to the imaging apparatus from the computer to effect manual duplex imaging.

### SUMMARY OF THE INVENTION

The present invention provides a manual duplex imaging method which avoids the need for a user to make multiple trips to the imaging apparatus from the computer to effect manual duplex imaging.

The invention, in one form thereof, is directed to a method for performing manual duplex imaging. The method includes the steps of providing a computer; providing an imaging apparatus communicatively coupled to the computer, the imaging apparatus including a media supply tray for holding print media loaded into the media supply tray; selecting a manual duplex imaging mode on the computer; communicating a first portion of a data file from the computer to the imaging apparatus to effect imaging on a first side of the print media; reloading the print media into the media supply tray on the imaging apparatus in preparation for imaging on a second side of the print media; sending a signal from the imaging apparatus to the computer indicating that the print media has been reloaded; and communicating a second portion of the data file from the computer to the imaging apparatus in response to the signal to effect imaging of the second side of the print media.

The invention, in another form thereof, is directed to an imaging system. The imaging system includes a computer having a monitor. A simplex imaging apparatus is communicatively coupled to the computer. The simplex imaging apparatus includes a media supply tray for holding print media loaded into the media supply tray. The computer and the simplex imaging apparatus co-act in performing manual duplex imaging, including the steps of communicating a first portion of a data file from the computer to the simplex imaging apparatus to effect imaging on a first side of the print media; sending a signal from the simplex imaging apparatus to the computer indicating that preparation for imaging on a second side of the print media is complete, the signal being initiated by a user input at the simplex imaging apparatus; and communicating a second portion of the data file from the computer to the simplex imaging apparatus in response to the signal to effect imaging of the second side of the print media.

The invention, in still another form thereof, is directed to a printer driver for use in manual duplex printing, including program instructions for performing the steps of communicating a first portion of a data file from a computer to a simplex imaging apparatus to effect imaging on a first side of a print media; receiving a signal from the simplex imaging apparatus indicating that preparation for imaging on a second side of the print media is complete, the signal being initiated by a user input at the simplex imaging apparatus; and communicating a second portion of the data file from the computer to the simplex imaging apparatus in response to the signal to effect imaging of the second side of the print media.

An advantage of the present invention is that the need for a user to make multiple trips to the imaging apparatus from the computer during manual duplex imaging is avoided.

Another advantage of the present invention is that manual duplex imaging can be performed by an imaging apparatus, such as a printer, that has insufficient memory to store at one time an entire page of a print job sent to the imaging apparatus from a computer.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a diagrammatic representation of an imaging system embodying the present invention; and

FIG. 2 is a flowchart of a method of the present invention.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

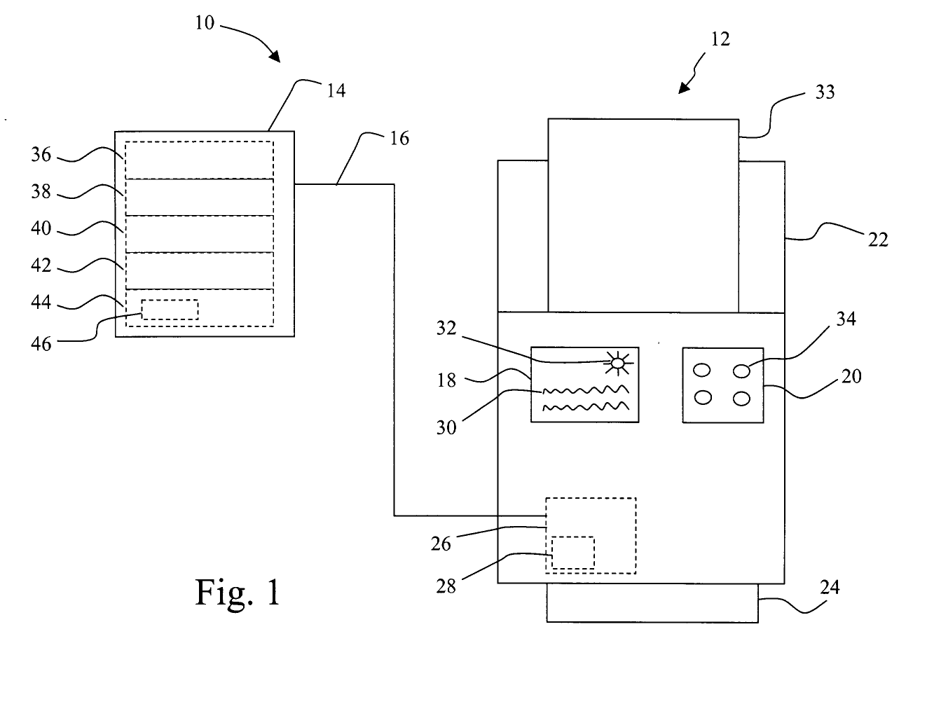

Referring now to the drawings, and particularly to FIG. 1, there is shown a diagrammatic representation of an imaging system 10 for implementing the method of the present invention. Imaging system 10 includes an imaging apparatus 12, a computer 14, and a communications link 16. Imaging apparatus 12 communicates with computer 14 via communications link 16.

Imaging apparatus 12 includes a display 18, a control panel 20, a media supply tray 22, a media exit tray 24, a controller 26 and a memory unit 28. Imaging apparatus 12 can be, for example, an ink jet or electrophotographic printer, or a multi-function machine. Imaging apparatus 12 is a type which operates as a simplex imaging apparatus, and thus, will sometimes be referred to as simplex imaging apparatus 12.

Display 18 is used to display text messages 30, and can be used to illuminate an indicator light 32. Display 18 may be, for example, a plasma display or a liquid crystal display (LCD). Alternatively, display 18 can be indicator lights, without a text display.

Control panel 20 is provided to permit local user input to imaging apparatus 12, and includes a plurality of buttons, such as control button 34, that serve as user input devices, and each having associated therewith predefined or programmable functions.

Each of media supply tray 22 and media exit tray 24 is designed to accommodate print media 33, such as paper, of a variety of sizes, such as 8.5×11, A4 and legal sizes.

Controller 26 is communicatively coupled to memory unit 28. Controller 26 is also communicatively coupled to communications link 16. Controller 26 includes a processor for executing program instructions for controlling, for example, the paper feed and imaging operations of imaging apparatus 12.

Memory unit 28 includes random access memory (RAM), read-only memory (ROM) and non-volatile memory (NVRAM). Memory unit 28 is used to store the program instructions executed by controller 26, as well as to store imaging data received from computer 14 via communications link 16.

Computer 14 may be, for example, a personal computer including a monitor 36, an input device (e.g., keyboard) 38, a processor 40, a memory device 42, including RAM, ROM, NVRAM, and a storage device 44, such as a hard drive, CD-ROM and/or DVD units. Resident in storage device 44 is a software program that includes program instructions that function as an imaging driver, e.g., a printer driver, as represented by block 46, for communicating formatted imaging data and imaging commands to imaging apparatus 12. Imaging driver 46 also is used in generating display windows on monitor 36 relating to imaging apparatus 12. To effect imaging operations, such as manual duplex imaging, imaging driver 46 is transferred from storage device 44 to memory device 42 for working access by processor 40.

Communications link 16 may be established by, for example, a direct connection, such as a cable connection, between imaging apparatus 12 and computer 14; by a wireless connection, such as Bluetooth; or by a network connection, such as for example, an Ethernet local area network (LAN) or a wireless networking standard, such as IEEE 802.11.

In preparation for imaging, computer 14 is communicatively coupled to simplex imaging apparatus 12 via communications link 16. Also, media supply tray 22 is loaded with print media 33, such as paper.

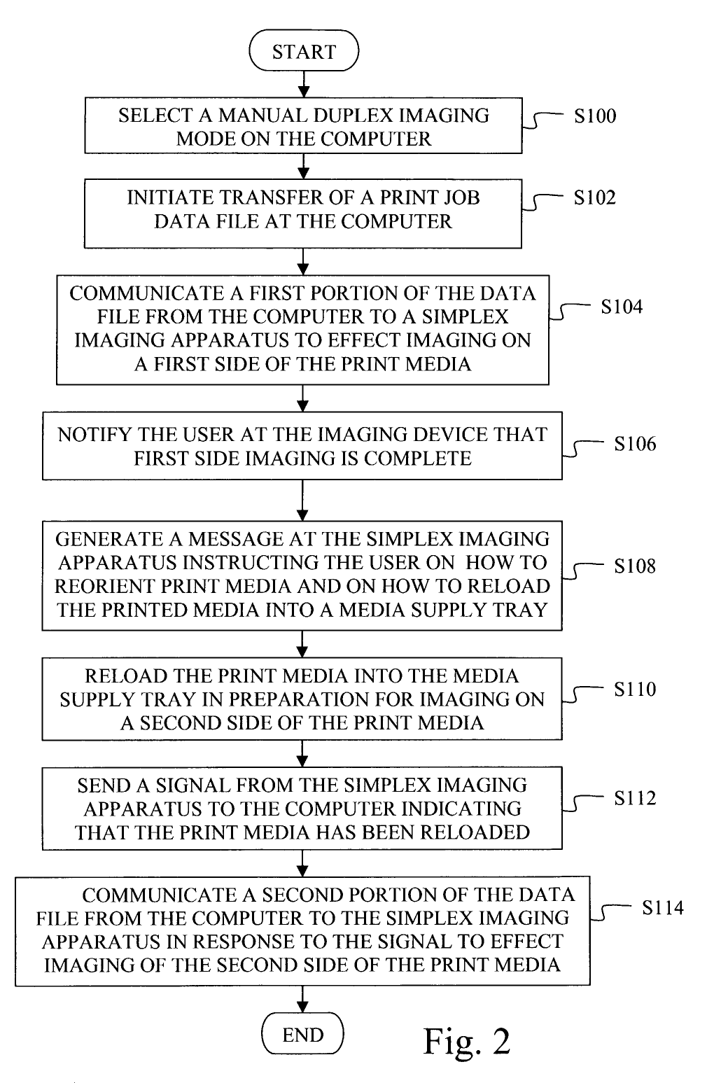

FIG. 2 is a flowchart of a method of manual duplex imaging on a simplex imaging apparatus. In FIG. 2, the steps performed by computer 14 are controlled by program instructions of imaging driver 46, executed by computer 14. The processing of user inputs at simplex imaging apparatus 12 is performed by software or firmware executed by controller 26 of simplex imaging apparatus 12.

At step S100, a user selects a manual duplex imaging mode on computer 14, which in turn invokes the program instructions of imaging driver 46. Through imaging driver 46, a manual duplex imaging instruction window is opened on monitor 36. This manual duplex imaging instruction window can include, for example, instructions for effecting manual duplex imaging using simplex imaging apparatus 12.

At step S102, the user initiates a transfer of a print job data file at computer 14 for imaging at simplex imaging apparatus 12. This step can include, for example, the opening of a text document for printing and then selecting a print command.

At step S104, computer 14 communicates a first portion of a data file from computer 14 to simplex imaging apparatus 12 to effect imaging on a first side of print media 33. Step S104 can include, for example, the printing of one or more sheets of print media 33 on one side of each sheet. Further, if the storage capacity of memory unit 28 is not sufficient to store an entire page of imaging data, the first portion of the data file is sent from computer 14 to simplex imaging apparatus 12 in multiple transmissions of bands of imaging data, wherein the page includes multiple bands of imaging data.

At step S106, the user located at computer 14 is notified that the first side imaging is complete. For example, when the imaging of the first portion of the data file is complete, a message can be displayed in the manual duplex imaging instruction window opened on monitor 36. Alternatively, imaging driver 46 can generate a notification message that is displayed in the manual duplex imaging instruction window after computer 14 is finished communicating the first portion of the data file to imaging apparatus 12. In either case, the user is notified that first side imaging of print media 33 is complete. At this time, the user travels to the location of simplex imaging apparatus 12.

At step S108, before the user arrives at simplex imaging apparatus 12, a message is generated at simplex imaging apparatus 12, for example by controller 26 using data retrieved from memory unit 28, or from data received from imaging driver 46, instructing the user on how to complete the manual duplex imaging process. In particular, the user is instructed on how to orient the print media 33 retrieved from media exit tray 24 following first side imaging, and on how to reload print media 33 that was retrieved from media exit tray 24 into media supply tray 22. Further, the user may be instructed as to which button of control panel 20 to push, such as control button 34, to continue manual duplex imaging. The generated message may be in the form of a printed sheet printed by imaging apparatus 12, thereby providing a printout of the instructions. Alternatively, the message may be displayed on display 18 of simplex imaging apparatus 12.

As a further alternative, a blinking light, such as indicator light 32, may be used to indicate to the user that first side imaging on print media 33 is complete and that print media 33 should be oriented and reloaded for second side imaging.

By following the instructions of step S108, at step S110, the user reloads print media 33 retrieved from media exit tray 24 into media supply tray 22 on simplex imaging apparatus 12 in preparation for imaging on a second side of print media 33.

At step S112, the user actuates control button 34 on control panel 20 of simplex imaging apparatus 12 to send a signal from simplex imaging apparatus 12 to computer 14 indicating that print media 33 has been reloaded into media supply tray 22. In other words, the signal indicates that preparation for imaging on the second side of print media 33 is complete. Control button 34 may be, for example, a paper feed button.

At step S114, computer 14 communicates a second portion of the data file from computer 14 to simplex imaging apparatus 12 in response to the signal generated in step S112 to effect imaging of the second side of print media 33. Imaging driver 46 handles the reordering of pages for the second side imaging of print media 33.

Again, if the storage capacity of memory unit 28 of simplex imaging apparatus 12 is not sufficient to store an entire page of imaging data, the second portion of the data file is sent from computer 14 to simplex imaging apparatus 12 in multiple transmissions of bands of imaging data, wherein the page includes multiple bands of imaging data. The manual duplex imaging instruction window opened in step S100 is cleared after the signal sent from simplex imaging apparatus 12 is received by computer 14.

By performing at least steps S104, S112 and S114 in the order presented in FIG. 2, the present invention facilitates manual duplex imaging on a simplex imaging apparatus that does not include sufficient memory to store an entire page of imaging data, as well as on a simplex imaging apparatus that does include sufficient memory to store an entire page of imaging data.

Those skilled in the art will recognize that the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for performing manual duplex imaging, comprising the steps of:
providing a computer;
providing an imaging apparatus communicatively coupled to said computer, said imaging apparatus including a media supply tray for holding print media loaded into said media supply tray;
selecting a manual duplex imaging mode on said computer;
communicating a first portion of a data file from said computer to said imaging apparatus to effect imaging on a first side of said print media;
reloading said print media into said media supply tray on said imaging apparatus in preparation for imaging on a second side of said print media;
sending a signal from said imaging apparatus to said computer indicating that said print media has been reloaded; and
communicating a second portion of said data file from said computer to said imaging apparatus in response to said signal to effect imaging of said second side of said print media.

2. The method of claim 1, wherein said imaging apparatus includes an input device to initiate said signal.

3. The method of claim 2, wherein said input device is a control button.

4. The method of claim 1, further comprising the step of notifying a user at said computer that said imaging on said first side of said print media is complete.

5. The method of claim 1, further comprising the step of displaying instructions at said imaging apparatus on how to complete said reloading of said print media.

6. The method of claim 5, wherein the displayed instructions instructs a user to press a button to initiate said sending step.

7. The method of claim 5, wherein said instructions are displayed on a printed sheet printed by said imaging apparatus.

8. The method of claim 5, wherein said instructions are displayed on a display of said imaging apparatus.

9. The method of claim 1, further comprising the steps of generating a manual duplex imaging instruction window on a monitor of said computer, and wherein said manual duplex imaging instruction window is cleared after said signal is received by said computer.

10. An imaging system, comprising:
a computer having a monitor; and
a simplex imaging apparatus communicatively coupled to said computer, said simplex imaging apparatus including a media supply tray for holding print media loaded into said media supply tray,
wherein said computer and said simplex imaging apparatus co-act in performing manual duplex imaging, including the steps of:
communicating a first portion of a data file from said computer to said simplex imaging apparatus to effect imaging on a first side of said print media;
sending a signal from said simplex imaging apparatus to said computer indicating that preparation for imaging on a second side of said print media is complete, said signal being initiated by a user input at said simplex imaging apparatus; and
communicating a second portion of said data file from said computer to said simplex imaging apparatus in response to said signal to effect imaging of said second side of said print media.

11. The imaging system of claim 10, wherein prior to said sending step, a user reloads said print media into said media supply tray on said simplex imaging apparatus in preparation for imaging on said second side of said print media.

12. The imaging system of claim 10, wherein said simplex imaging apparatus includes an input device to initiate said signal.

13. The imaging system of claim 12, wherein said input device is a control button.

14. The imaging system of claim 10, wherein a message is displayed on said monitor indicating that said imaging on said first side of said print media is complete.

15. The imaging system of claim 10, wherein said simplex imaging apparatus includes an indicator device that indicates to the user at said simplex imaging device to reload said print media in said media supply tray in preparation for second side imaging of said print media.

16. The imaging system of claim 10, wherein said simplex imaging apparatus includes a display that displays instructions on how to complete said reloading of said print media.

17. The imaging system of claim 16, wherein the displayed instructions instructs a user to press a button to initiate said sending step.

18. The imaging system of claim 16, wherein said instructions are displayed on a printed sheet printed by said imaging apparatus.

19. The imaging system of claim 16, wherein said instructions are displayed on a display of said imaging apparatus.

20. The imaging system of claim 10, further comprising a printer driver executed on said computer for generating a manual duplex imaging instruction window on said monitor, and wherein said manual duplex imaging instruction window is cleared after said signal is received by said computer.

21. The imaging system of claim 10, wherein said computer is communicatively coupled to said simplex imaging apparatus via a network.

22. A printer driver for use in manual duplex printing, including program instructions for performing the steps of:
communicating a first portion of a data file from a computer to a simplex imaging apparatus to effect imaging on a first side of a print media;
receiving a signal from said simplex imaging apparatus indicating that preparation for imaging on a second side of said print media is complete, said signal being initiated by a user input at said simplex imaging apparatus; and
communicating a second portion of said data file from said computer to said simplex imaging apparatus in response to said signal to effect imaging of said second side of said print media.

23. The printer driver of claim 22, including program instructions for performing the step of generating a manual duplex imaging instruction window on a monitor of said computer.

24. The printer driver of claim 23, wherein said manual duplex imaging instruction window is cleared after said signal is received by said printer driver.
